(19) United States
(12) Patent Application Publication
(10) Pub. No.: US 2003/0108026 A1
(43) Pub. Date: Jun. 12, 2003

(54) Power level detection for mobile communication system

(76) Inventors: Kari Jyrkka, Oulu (FI); Erno Tormikoski, Oulu (FI)

Correspondence Address: SCHEEF & STONE, L.L.P., 5956 SHERRY LANE, SUITE 1400, DALLAS, TX, 75225, US

(21) Appl. No.: 10/238,493

(22) Filed: Sep. 10, 2002

(30) Foreign Application Priority Data
Sep. 11, 2001 (GB) 0122008.6

(51) Int. Cl. H04J 3/00

(52) U.S. Cl. 370/345; 455/522

(57) ABSTRACT

There is disclosed a method and apparatus for determining a received signal level in a discontinuous broadcast control channel in which a control signal identifying the power level is periodically transmitted in n blocks, each being one frame apart and each frame comprising m blocks. The technique comprises: i) measuring the received power level in a first frame at a first timing position, ii) measuring the received power level at n successive frame intervals, iii) averaging the n measured received power levels, iv) repeating steps i to iii for a plurality of timing positions, and v) determining the averaged n measured received power level having the highest value to be the received power level.

### FIELD OF THE INVENTION

The present invention relates to the determination of received power levels in mobile communication systems having discontinuous control channels, and particularly but not exclusively to GSM systems.

### BACKGROUND TO THE INVENTION

A GSM (global system for mobile communications) system feature known as ‘Compact Mode’ utilises a discontinuously transmitting control channel. This discontinuous transmission on the broadcast control channel in a synchronous network enables GSM network deployment with only 1 MHz of bandwidth instead of the 2.5 MHz requirement needed with continuously transmitting control channels. The Compact Mode control channel was specified for IS136+EGPRS systems so that current IS136 system operators could deploy a new EGPRS overlay system with minimum initial spectrum allocation.

Since the Compact Mode introduced a discontinuous transmission channel to systems previously utilising constantly transmitting control channels, the feature clearly requires some change to existing implementations in mobile stations. Changes proposed include initial scanning of discontinuous control channels, synchronisation to discontinuously transmitting control channels, and neighbour cell measurements from discontinuous control channels.

One of the initial processing steps carried out in a mobile station on receipt of signals from a base station is to determine the received signal level, i.e. the strength of signals received at the mobile station. In GSM system this measurement is made on the broadcast control channel, which traditionally has been transmitted continuously. In such systems, a single random measurement will suffice.

However, since the compact packet broadcast control channel (compact PBCCH) is discontinuous, a single random measurement will not suffice. It has been proposed in one GSM specification that a single reading may instead consist of taking the maximum value out of multiple measurements. The succeeding averaging is based on at least five such measurement readings per carrier in the discontinuous control channel, where readings are at least one second apart. The average signal strength estimate is then made on the basis of the maximum received signal level readings. This procedure is referred to as a Compact PBCCH scan.

There are two specific problems associated with the existing GSM Compact PBCCH scan specification proposals.

The first problem is that the specification suggests taking multiple received signal level measurements and taking the maximum of those. However, if the maximum value is taken from multiple measurements then the resulting average received signal level value does not represent the channel average power level. Instead the measurement method estimates the average maximum received signal level of the fading channel. Measurement results over continuous and discontinuous channels are not comparable: measurements over continuous channels represent the average power of a fading channel; whereas measurements over a discontinuous channel represent the average maximum of the channel. Thus the proposed method does not give the average received signal level value in a fading channel situation, but finds the positions where the receive levels in the fading channel are at the “strongest” position. Experimental results have suggested that this typically gives 5-7 dB too high average received signal estimate levels.

Thus when a mobile station is commanded to measure both continuously transmitting control carriers and discontinuous control carriers the received signal level scan, i.e. the Compact PBCCH scan, over discontinuous control carriers gives too optimistic signal strength estimates for discontinuous carriers, and continuous carriers are easily neglected during initial cell selection.

The second problem is the requirement that the maximum values should be taken at least one second apart in all conditions. The proposed specification suggests an implementation where multiple measurements should be taken from a single carrier, the maximum measurement selected, and then the process repeated for the next carrier. When all the carriers of the band are measured then carriers are measured again to average the fading channel effect. One second between the same carrier measurements is sufficient to guarantee uncorrelated measurement results. Simple fading channel simulations suggest that signal power varies from maximum to minimum power within one GSM TDMA frame period. Therefore it should be sufficient to take those averaging results within a 4.615 ms TDMA frame period. In practice, however, it is difficult to make accurate measurements over a wide dynamic range when no information is known about the expected level.

In order to make initial reliable received signal level readings from the Compact carrier it is preferable to be able to adjust the automatic gain control (AGC) of the mobile station to tune the receiver to the correct dynamic level to capture the signal. In order to adjust the AGC, it is necessary to first listen long enough to capture at least some signal from the discontinuous carrier.

Therefore the AGC adjustment problem requires that first the system must listen long enough to adjust AGC, and then take all receive level readings from that carrier before moving to the next carrier, where the AGC adjustment problem must also be handled. A problem in a suggested solution is adjusting the automatic gain control (AGC) prior to receive level measurements if the 120 seconds specification for initial network selection is to be met.

It is an aim of the present invention to provide a technique that overcomes the stated problems.

### SUMMARY OF THE INVENTION

In accordance with the present invention there is provided a method of determining a received signal level in a discontinuous broadcast control channel in which a control signal identifying the power level is periodically transmitted in n blocks, each being one frame apart and each frame comprising m blocks, the method comprising: i) measuring the received power level in a first frame at a first timing position, ii) measuring the received power level at n successive frame intervals, iii) averaging the n measured received power levels, iv) repeating steps i to iii for a plurality of timing positions, and v) determining the averaged n measured received power level having the highest value to be the received power level.

In slow-fading conditions the technique may be repeated to obtain multiple measurements. In one embodiment, the technique is repeated once every second. However, in fast-fading conditions such multiple measurements are not required.

Steps i to iii are preferably repeated continuously. Steps i to iii are preferably repeated for a plurality of timing positions in a pre-determined measuring period.

A time division multiple access system, incorporating a method as defined above, and in which each block of a frame may correspond to a time slot.

The broadcast control channel may be a packet broadcast control channel. The broadcast control channel may be transmitted in a compact mode in a GSM system.

The control signal may be transmitted in a particular burst of a TDMA frame.

Preferably n is 4 and m is 8. Preferably each successive timing position is one block apart.

The system is preferably a GSM system and the measuring period is preferably 110 blocks, each block corresponding to a GSM burst.

The step of averaging the measured values may include integrating the measured values.

In accordance with a further aspect the present invention provides a receiver for receiving signals in a broadcast control channel, the broadcast control channel being discontinuous and in which a control signal is periodically transmitted in n blocks, each being one frame apart and each frame comprising m blocks, the receiver comprising: measuring means for measuring the received power level in a first frame in an initial timing position and for measuring the received power level in n successive frames at n successive frame intervals; averaging means for averaging the n measured received power levels; means for controlling the measuring means and the averaging means to measure and average for a plurality of initial timing positions; and means for determining the averaged received power level having the highest value, such value being determined to be the received power level.

The means for controlling is preferably adapted to control the means for measuring and the means for averaging to continuously measure and average.

The means for controlling is preferably adapted to control the means for measuring and the means for averaging to continuously measure and average over a pre-determined period.

A receiver as defined in a time division multiple access system, wherein the control signal may be transmitted in a particular time-slot of each frame.

The broadcast control channel may be a packet broadcast control channel. The broadcast control channel may be transmitted in a compact mode in a GSM system. The control signal may be transmitted in a particular burst of a TDMA frame. Preferably n is 4.

The receiver may further comprise a store for storing the successive averaged values.

In a still further aspect the present invention provides a mobile communication system including a transmitter for transmitting signals in a broadcast control channel, the broadcast control channel being discontinuous and in which a control signal is periodically transmitted in n blocks each block being one frame apart, the system further including a receiver for receiving signals in the broadcast channel from the transmitter, the receiver comprising: an integrator for measuring the received power level in n successive timing locations, each being one frame apart and means for averaging the n measured received power levels; a controller for controlling the integrator to measure and average a plurality of sets of n successive timing locations for a plurality of starting time locations; and a comparator for determining the averaged n measured received power level having the highest value, such value being determined to be the received power level.

The mobile communication system is preferably a GSM system. The receiver is preferably provided in a mobile station of the system. The transmitter is preferably provided in a base transceiver station of the system.

### BRIEF DESCRIPTION OF THE FIGURES

The present invention will now be described by way of nonlimiting example with reference to the accompanying drawings, in which:

FIG. 1 illustrates the format of the Compact PBCCH for GSM; and

FIG. 2 illustrates in block diagram form the functional elements required to implement the present invention.

### DESCRIPTION OF PREFERRED EMBODIMENTS

The present invention is described herein with specific reference to a GSM system, and as such certain system parameters and requirements of GSM systems are referred to. However the present invention is not limited to a GSM system or the system parameters of such, and it will be apparent from the following description how the invention may be more broadly applied.

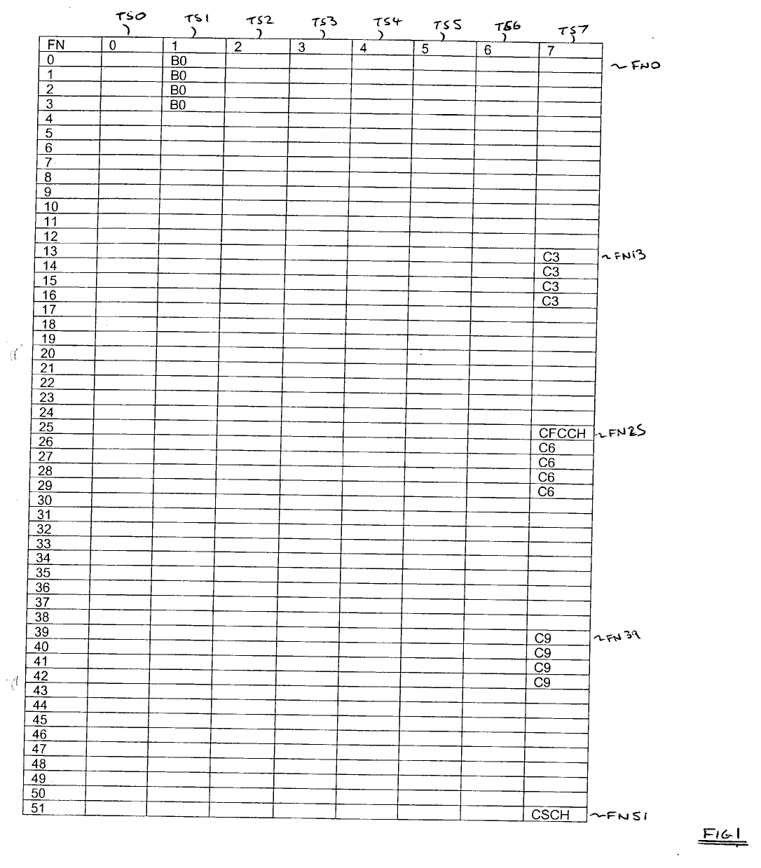

Referring to FIG. 1, there is illustrated an example of a compact 52-multiframe structure. For the purposes of illustration, the example in FIG. 1 is a worst-case scenario, as discussed further hereinbelow. The compact 52-multiframe structure is known from the ETSI EN 300 908 V8.3.0 (2000-01) European Standard. As can be seen from FIG. 1, a frame comprises 8 GSM bursts and a multiframe comprises 52 frames, and is hence termed a 52-multiframe.

The compact control channel signalling block is transmitted multiple times during a GSM 52-multiframe period. Each compact control channel signalling block comprises four GSM bursts transmitted in consecutive GSM TDMA frames, exactly one TDMA frame apart. In relation to the multiple transmission of the signalling blocks, the maximum number which may be transmitted in a 52-multiframe period is 12 blocks, and the minimum number which may be transmitted in a 52-multiframe period is four blocks.

The position of each compact control channel signalling block also rotates from one 52-multiframe to another. For example, in a first 52-multiframe time period, a signalling block is in time slot TS1, in the second 52-multiframe period in time slot TS3, in the third 52-multiframe period in time slot TS5, and in the fourth 52-multiframe period in time slot TS7. In this way, it takes a total of four 52-multiframe periods before a compact control channel signalling block timing repeats itself. It will be clear, however, that the information in that signalling block is repeated in every 52-multiframe.

The minimum configuration of four compact control channel signalling blocks in a 52-multiframe is the most difficult to measure, since there is only a minimal amount of signal to detect. The blocks must be evenly distributed, i.e. there must be one of the four blocks in each of the 13 frames of the 52-multiframe. Furthermore, in the four compact control channel case the longest period of silence occurs when the one signalling block is transmitted in time slot TS1, and the next signalling block is transmitted in time slot TS7. Thus, the longest silence period is 9 full TDMA frames (equivalent to 104 GSM bursts), plus five timeslots or bursts.

So, the maximum silence period is (9×8)+5 bursts. However the next signalling block is four bursts over four frames, and therefore the total listening period required in a worst case scenario to ensure ‘capture’ of one compact control channel signalling block is (13×8)+6, which is equal to 110 GSM bursts. Thus the minimum listening period required to capture a compact control channel signalling block is 110 GSM bursts.

This worst-case scenario is illustrated in FIG. 1. Only four compact control channel signalling blocks are transmitted during the 52-multiframe. Each of these compact control channel signalling blocks comprises four GSM bursts, each being exactly one TDMA frame apart. Referring to FIG. 1, a first compact control channel signalling block comprises four GSM bursts BO, starting in frame number FN0, and each located in time slot TS1.

Similarly, the second compact control channel signalling block comprises four GSM bursts C3 starting in frame number FN13, time slot TS7, the third compact control channel signalling block comprises four GSM bursts C6 starting in frame number FN25, time slot TS7, and the fourth compact control channel signalling block comprises four GSM bursts C9 starting in frame number FN39, time slot TS7.

In the example of FIG. 1, the first compact control channel signalling block B0 comprises CPBCCH, and the second to third compact control channel signalling blocks C3, C6 and C9 comprise CPCCCH.

In order to find the position of the four bursts of a Compact Control Channel signalling block, it is thus necessary to take received signal level readings constantly over a 110 GSM burst time period, and then process these readings. The measurement results from that period are preferably stored to enable post-processing to determine the exact location of the compact control channel signalling block. The position of the Compact Control Channel signalling block is searched by filtering the received signal level measurements with a 4-tap integrator that sums the received signal levels that are exactly one TDMA frame period apart from each other. The integrator maximum received level value occurs at the Compact Control Channel signalling block position. That is, referring to the example of FIG. 1, when the four bursts in time slot TS1 are of frames FN0 to FN3 are presented at the four taps of the integer.

In this particular example four sets of values are looked at simultaneously, as the GSM specification transmits the discontinuous control channel over four TDMA frames, as exemplified by FIG. 1. In general, however, for a discontinuous control channel transmitted over n frames the received power level may be obtained by measuring the received power level in a first frame, measuring the received power level in the successive n−1 frames, and repeating this process for all frames within the period within which the control channel may be transmitted. Each of the measured power levels are averaged, and the highest average value provides the estimate of the received signal power level.

The maximum integrator value is then selected as one received signal level reading for that particular carrier.

If the measurement is carried out from the fast fading channel, the single received signal level reading produces a reliable average power estimate, since the four received signal level samples are averaged in the integrator to obtain a single received signal level reading.

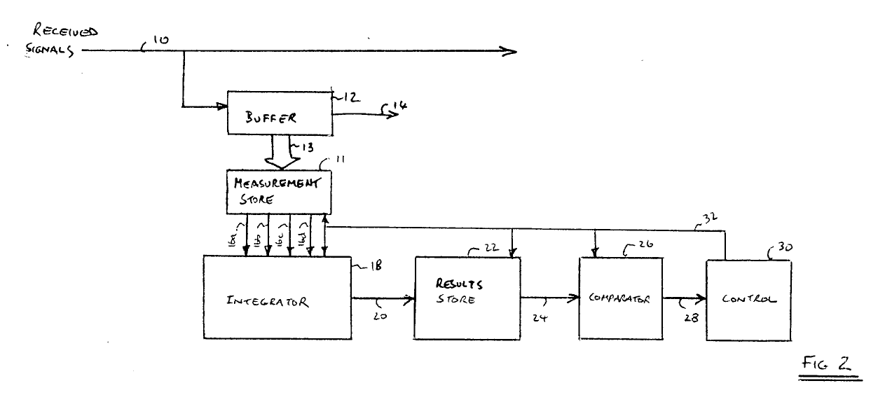

Referring to FIG. 2, an exemplary illustration of a receiver for implementing the present invention is shown. It should be noted that only the main functional elements for implementing the present invention are shown, and that a receiver additionally comprises further functional elements for processing a received signal.

FIG. 2 shows a buffer 12, a measurement store 11, an integrator 18, a results store 22, a comparator 26, and a control block 30.

As discussed hereinabove, the Compact Control Channel signalling block is transmitted as GSM bursts, each burst being one frame apart from each other. Thus, in accordance with the described embodiment of the present invention, the received signal on line 10 is provided as an input to the buffer 12. The buffer 12 provides a measurement, over a 100 burst period, for each burst received, to the measurement store 11 via lines 13. In this way, measurements for all 110 are stored in the measurement store 11.

The stored results measured from each of the 110 bursts are then post-processed by the integrator 18. The integrator 14 is a 4-tap integrator, in view of the fact that the Compact Control Channel signalling block is contained in four bursts, each one TDMA frame apart. The 4-tap integrator sums the received signal levels of bursts that are exactly one TDMA frame apart from each other.

The measurement store 11 is thus provided with four outputs, 16a to 16d. Each of the outputs is derived from the buffer such that the signals provided on the respective output lines 16a to 16d are one TDMA frame apart. The signals output from the buffer 12 on lines 16a to 16d form respective inputs to the four-tap integrator 18.

The integrator integrates successive signals applied at its four taps, and generates an output for each set of inputs on line 20, such that the outputs from the integrator are stored in the results store 22, which preferably comprises a memory. In addition to storing the values at the output of the integrator, the store additionally stores the positioning of the received signal for that value. When the measurement period is complete, the stored values are transferred from the store 22 to the comparator 26 under the control of the control block 30 via lines 32. The comparator determines which of the stored values is the highest, and provides such result to the control block via lines 28. The highest, or maximum, result gives the position of the Compact Control Block in the f110 GSM bursts analysed. The control block is then able to determine the further processing of the received signal based on the estimate of the received signal position provided by the estimate technique of the present invention.

Whilst the above-described technique works efficiently in fast-fading channel conditions, in slowly-fading channel conditions it may be necessary to make multiple received level signal readings. In such cases multiple measurements may be taken one second apart, as per the GSM specification, to make successive measurements independent from each other. The present invention provides a further advantage in such a scenario, however. The first measurement result provides the exact position of the compact control block, and thus any following measurements can be made immediately in the correct timing position.

It should also be noted that FIG. 2 illustrates one example implementation of a technique for performing the present invention. Other implementations are possible and will be apparent to one skilled in the art.

The present invention is advantageous over the previously proposed technique.

The method calculates the received signal level average for four received signal levels taken one TDMA frame apart from each other, and therefore the taking of measurements only in situations where the fading channel was strongest is avoided. The technique of the present invention is therefore more reliable than that proposed in the GSM specification, which suggests taking five readings randomly.

The invention may be advantageously used in a mobile communication system and is particularly useful in a GSM system. The invention is preferably utilised in a receiver of such a system. The receiver is preferably provided in a mobile station of the system. The transmitter is preferably provided in a base transceiver station of the system.

While the present invention has been described with reference to certain preferred embodiments and applications, those skilled in the art to which the present invention applies will now, as a result of the teaching presented herein, recognise that various modifications may be made and other embodiments provided without departing from the scope of the invention as defined in the appended claims.

1. A method of determining a received signal level in a discontinuous broadcast control channel in which a control signal identifying the power level is periodically transmitted in n blocks, each being one frame apart and each frame comprising m blocks, the method comprising: i) measuring the received power level in a first frame at a first timing position, ii) measuring the received power level at n successive frame intervals, iii) averaging the n measured received power levels, iv) repeating steps i to iii for a plurality of timing positions, and v) determining the averaged n measured received power level having the highest value to be the received power level.

2. A method according to claim 1, wherein steps i to iii are repeated continuously.

3. A method according to claim 1, wherein steps i to iii are repeated or a plurality of timing positions in a pre-determined measuring period.

4. A method according to claim 1 in a time division multiple access system, wherein each block of a frame corresponds to a time slot.

5. A method according to claim 1, wherein the broadcast control channel is a packet broadcast control channel.

6. A method according to claim 5 wherein the broadcast control channel is transmitted in a compact mode in a GSM system.

7. A method according to claim 6 wherein the control signal is transmitted in a particular burst of a TDMA frame.

8. A method according to claim 1 in which n is 4 and m is 8.

9. A method according to claim 1 wherein each successive timing position is one block apart.

10. A method according to claim 3 wherein the system is a GSM system and the measuring period is 110 blocks, each block corresponding to a GSM burst.

11. A method according to claim 1 in which the step of averaging the measured values includes integrating the measured values.

12. A receiver for receiving signals in a broadcast control channel, the broadcast control channel being discontinuous and in which a control signal is periodically transmitted in n blocks, each being one frame apart and each frame comprising m blocks, the receiver comprising: measuring means for measuring the received power level in a first frame in an initial timing position and for measuring the received power level in n successive frames at n successive frame intervals; averaging means for averaging the n measured received power levels; means for controlling the measuring means and the averaging means to measure and average for a plurality of initial timing positions; and means for determining the averaged received power level having the highest value, such value being determined to be the received power level.

13. A receiver according to claim 12, wherein the means for controlling is adapted to control the means for measuring and the means for averaging to continuously measure and average.

14. A receiver according to claim 13 wherein the means for controlling is adapted to control the means for measuring and the means for averaging to continuously measure and average over a pre-determined period.

15. A receiver according to claim 12 in a time division multiple access system, wherein the control signal is transmitted in a particular time-slot of each frame.

16. A receiver according to claim 12 wherein the broadcast control channel is a packet broadcast control channel.

17. A receiver according to claim 16 wherein the broadcast control channel is transmitted in a compact mode in a GSM system.

18. A receiver according to claim 17 wherein the control signal is transmitted in a particular burst of a TDMA frame.

19. A receiver according to claim 12 in which n is 4.

20. A receiver according to claim 9 further comprising a store for storing the successive averaged values.

21. A mobile communication system including a transmitter for transmitting signals in a broadcast control channel, the broadcast control channel being discontinuous and in which a control signal is periodically transmitted in n blocks each block being one frame apart, the system further including a receiver for receiving signals in the broadcast channel from the transmitter, the receiver comprising: an integrator for measuring the received power level in n successive timing locations, each being one frame apart and means for averaging the n measured received power levels; a controller for controlling the integrator to measure and average a plurality of sets of n successive timing locations for a plurality of starting time locations; and a comparator for determining the averaged n measured received power level having the highest value, such value being determined to be the received power level.

22. The mobile communication system of claim 21 wherein the system is a GSM system.

23. The mobile communication system of claim 21 wherein the receiver is provided in a mobile station of the system

24. The mobile communication system of claim 21 wherein the transmitter is provided in a base transceiver station of the system.
